(19) United States
(12) Patent Application Publication
(10) Pub. No.: US 2004/0257578 A1
(43) Pub. Date: Dec. 23, 2004

(54) Optical pulse characterization for telecommunications applications

(75) Inventor: Daniel J. Kane, Santa Fe, NM (US)

Correspondence Address: PEACOCK MYERS AND ADAMS P C, P O BOX 26927, ALBUQUERQUE, NM, 871256927

(73) Assignee: SOUTHWEST SCIENCES INCORPORATED, Santa Fe, NM

(21) Appl. No.: 10/803,743

(22) Filed: Mar. 17, 2004

Related U.S. Application Data
(60) Provisional application No. 60/455,530, filed on Mar. 18, 2003.

(51) Int. Cl. G01B 9/02

(52) U.S. Cl. 356/450

(57) ABSTRACT

An apparatus and method for optical pulse characterization comprising employment of an intensity modulator receiving optical pulses, a spectrometer receiving output from the intensity modulator, a detector receiving output from the spectrometer, a phase shifter receiving a gate pulse and providing output to the intensity modulator, and information processing means receiving output from the detector and providing commands to the phase shifter.

### CROSS-REFERENCE TO RELATED APPLICATIONS

This application claims the benefit of the filing of U.S. Provisional Patent Application Ser. No. 60/455,530, entitled “Optical Pulse Characterization for Telecommunications Applications”, filed on Mar. 18, 2003, and the specification thereof is incorporated herein by reference.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract No. DMI-0215045 awarded by the U.S. National Science Foundation (NSF).

### BACKGROUND OF THE INVENTION

1. Field of the Invention (Technical Field):

The technical field of this invention is the measurement of the intensity and phase of optical pulses used in telecommunication systems.

2. Background Art

Note that the following discussion refers to a number of publications by author(s) and year of publication, and that due to recent publication dates certain publications are not to be considered as prior art vis-a-vis the present invention. Discussion of such publications herein is given for more complete background and is not to be construed as an admission that such publications are prior art for patentability determination purposes.

Internet traffic has been doubling every two years while transmission costs are dropping. Consolidation in the telecommunications sector as well as competition and over capacity are fueling this change. As a result, construction of more of the same equipment will not satisfy future needs and cost constraints—only improvements in technology will allow the transmission of more data at lower cost. The main mode for decreasing the cost per-unit-bandwidth of transmission is to increase the transmission rate. As the bandwidth of optical networks increases, difficulties arise not only in the transmission of data within the optical fibers, but also with transmission in and manufacture of optical components (amplifiers, filters, modulators, etc.). Dispersion, which increases with the square of the bandwidth, in fibers and components causes the pulses to become distorted, increasing the bit-error rate. J. Hecht, WDM Solutions, December (2001). As important as this problem is, no general purpose, real-time, in-situ devices exist for the measurement of dispersion in optical systems.

Present methods for measuring chirp for telecommunications applications include converting phase modulation to amplitude modulation using a discriminator, using a fiber-transfer function, measuring the optical spectrum after the pulse is passed through a phase modulator, and measuring the arrival time of frequency components. Unfortunately, these methods are slow and cumbersome; some require a time domain measurement while others are not very accurate.

The present invention provides a solution by, in part, employing a technique called frequency-resolved optical gating (FROG), as described in U.S. Pat. No. 5,754,292, “Method and apparatus for measuring the intensity and phase of an ultrashort light pulse” and U.S. Pat. No. 6,219,142, “Method and apparatus for determining wave characteristics from wave phenomenon.” Those patents are hereby incorporated by reference.

### BRIEF SUMMARY OF THE INVENTION

The present invention is of an apparatus and method for optical pulse characterization, comprising employment of: a modulator receiving optical pulses; a spectrometer receiving output from the modulator; a detector receiving output from the spectrometer; a phase shifter receiving a gate pulse and providing output to the modulator; and information processing means receiving output from the detector and providing commands to the phase shifter. In the preferred embodiment, the apparatus characterizes optical pulses as to one or more of the intensity, phase, dispersion, polarization states, chirp, and non-linear effects. The modulator (preferably an intensity modulator or a phase gate) is phase-locked to a train of the optical pulses, and the phase shifter provides a same effect as adjusting a time delay between the optical pulses and the gate pulse. Frequency-resolved optical gating is employed, with or without known gate, making no constraint between optical pulse and gate pulse. A spectral constraint is preferably applied to the frequency-resolved optical gating means. The technique of principal components generalized projections is preferably employed, most preferably with a spectral constraint.

The invention is also of a vector optical spectrum analyzer comprising: a modulator receiving optical pulses; a spectrometer receiving output from the modulator; a detector receiving output from the spectrometer; a phase shifter receiving a gate pulse and providing output to the modulator; information processing means receiving output from the detector and providing commands to the phase shifter; and a clock recovery circuit providing the gate pulse to the phase shifter. In the preferred embodiment, a switch provides input to the spectrometer alternatable between output of the modulator and the optical pulses as received by the modulator.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is a schematic diagram of a prior art second harmonic generation FROG device. An input beam is split into two replicas. The probe and the gate are combined in a non-linear medium and the resulting signal is spectrally resolved as a function of delay between the replicas.

FIG. 2 is a schematic diagram of an experimental apparatus for testing the invention. A standard telecommunications diode laser is sent into an intensity and phase modulator to form the pulse to measure. The pulses are sent into a FROG device that comprises an intensity modulator and an optical spectrum analyzer.

FIG. 3 is a FROG trace of a pulse directly from a Mach-Zender intensity modulator. From the intensity and phase, rise time and chirp parameter can be measured.

FIG. 4(a) is a FROG trace of a phase modulated pulse. FIG. 4(b) is the retrieved intensity (solid line) and phase (dotted line). FIG. 4(c) shows the spectrum of the phase-modulated pulse (solid line); the spectrum of the pulse with the phase modulator off (dashed line), and the spectrum of the pulse shown in FIG. 4(b) if it had zero phase (circles).

FIG. 5 is a schematic diagram of a real-time telecommunications FROG device according to the invention. A 10.7 GHz oscillator is used as the master for generating the pulses to be measured and the gate. A phase adjust on the 10.7 GHz drive for the gate varies the relative delay between the pulse and the gate. The gated pulse is spectrally resolved using a 1 m spectrometer and recorded on the computer via an InGaAs array. The phase adjust is scanned under computer control. The area enclosed in the dotted box is the FROG device itself.

FIG. 6 is a measured FROG trace of a linearly chirped pulse. The frequency is clearly visible. Each pixel on the frequency axis corresponds to 10.7 GHz.

FIG. 7 is a plot of retrieved intensity from a LabView® real-time pulse measurement program according to the invention. The vertical axis is intensity in arbitrary units.

FIG. 8 is a plot of retrieved pulse phase. Vertical axis is in radians.

FIG. 9 is a schematic diagram of a vector optical spectrum analyzer according to the invention. Part of the input beam goes to the clock recovery circuit while the other part is measured. A splitter splits the measured beam again. Some of the beam is used for the spectral measurement while most of the beam is sent into the gating intensity modulator. A computer controls all of the data acquisition.

### DESCRIPTION OF THE PREFERRED EMBODIMENTS

### Best Modes for carrying out the invention

The present invention provides for real-time measurement of the intensity and phase of telecommunications pulses, and provides a self-contained, general purpose instrument and method for the measurement of the intensity and phase of optical pulses in telecommunications systems, subsystems, and components. The invention is also of a general-purpose device and method designed to measure pulse intensity and phase in functioning optical networks as they are transmitting data in real-time. The device is sensitive to all types of chirp whether caused by chromatic dispersion, polarization mode dispersion (PMD), or non-linear effects.

The inventive approach accurately and fully characterizes optical pulses in fiber optics, telecommunications components, and subsystems in real-time. The device and method of the invention employ a technique called frequency-resolved optical gating (FROG). Using simple, commercially available telecommunications components, the invention spectrally resolves time slices of the pulse to form its spectrogram. A two-dimensional phase retrieval algorithm extracts the desired information, the pulse intensity and phase, which contains all of the spectral and temporal information about the pulse.

One can combine FROG with spectral interferometry to measure telecommunications pulses. However, a better approach exists that is more suitable for telecommunications pulse measurement. The present invention provides real-time optical telecommunications pulse measurement using an intensity modulator to construct a real-time FROG device capable of measuring optical telecommunications pulses. Update rates are 2 Hz—faster than any known technique and the pulse measurement speed can be increased to better than 8 Hz. Such a device not only has the utility of a high-speed digital sampling oscilloscope and an optical spectrum analyzer, but can also directly measure chirp and dispersion in telecommunication components as well as measure chirp in optical networks as they are transmitting data. Because a single instrument can replace so many test and measurement devices, testing and maintenance costs can be reduced, lowering overall costs for manufacturing and research and development.

Telecommunications Pulse Measurement

As telecommunication systems move from the OC-192 (10 Gb/s) to OC-768 (40 Gb/s) specifications, dispersion becomes a factor in system design. Individual components as well as subsystems must be measured for dispersion; active components must be measured for chirp. For many devices, such as intensity modulators, chirp measurements must be made in the design as well as the manufacturing process. Worse, chromatic dispersion can change with temperature fluctuations, and polarization mode dispersion changes unpredictably in response to stresses in the optical components. As a result, both must be actively compensated. As speeds increase further to 160 Gbits/s, nonlinear effects such as self-phase modulation, cross phase modulation, four-wave mixing, stimulated Raman scattering, and stimulated Brillouin scattering will begin to affect pulse propagation. These effects will need to be fully characterized and possibly actively compensated. Because nonlinear effects are intensity and phase dependent, no measurement technique other than full pulse characterization is suitable for determining nonlinear effects on pulse propagation.

This application next provides background in the area of pulse measurement by first giving the mathematical representation of an optical pulse. Next, the pulse measurement technique of frequency-resolved optical gating is described. The application then introduces the specific technique preferred, denominated blind-FROG, together with a preferred principal components generalized projections (PCGP) algorithm.

Mathematical Representation of an Optical Pulse

E(t)=Re{\sqrt{I(t)} exp(iω₀t−iφ(t))},

The time-dependent electric field, E(t), of an optical pulse can be written:

E(t)=Re{\sqrt{I(t)} exp(iω₀t−iω(t))}

where I(t) and φ(t) are the time-dependent intensity and phase of the pulse, and ω₀ is the carrier frequency. The time-dependent phase contains the frequency versus time information. The pulse field can be written equally well in the frequency domain (neglecting

E(ω)=\sqrt{I}(ω−ω₀) exp(iφ(ω−ω₀)), the negative-frequency term):

E(ω)=\sqrt{I}(ω−ω₀) exp(iφ(ω−ω₀)),

where I(ω) is the spectrum of the pulse and φ(ω−ω₀) is its phase in the frequency domain. The spectral phase contains time versus frequency information. When the phase components are zero, the pulse has a bandwidth limited pulse width, or is “transform limited”.

Dispersion within an optical fiber causes different frequencies that make up the pulse to have different velocities, making the phase term non-zero. Thus, when an optical pulse undergoes linear dispersion by traveling through a fiber, the bluer spectral components of the pulse travel with a slightly different velocity than the redder components within the same pulse. The pulse then blurs in time and adjacent pulses can smear together. Mathematically, in the frequency domain, linear dispersion adds a quadratic phase to the frequency domain phase, φ. If the phase, or chirp is known, then the exact opposite phase, −φ, can be applied to the pulse to produce the original pulse. Consequently, fully characterizing the pulse to determine φ allows the dispersion compensation to be set exactly, cancelling all phase distortions, producing a perfect, transform limited pulse. No a priori knowledge of the phase distortions or the optical network is required.

Obtaining the intensity and phase, I(t) and φ(t) (or I(ω) and φ(ω−ω₀)) is called full characterization of the pulse. A very useful tool for ultrafast researchers to determine ultrashort laser pulse characteristics is the femtosecond oscilloscope. D. J. Kane, IEEE J. Quantum Electron. 35, 421 (1999); and D. J. Kane, IEEE J. Select. Topics Quantum Electron. 4, 278 (1998). The present invention renders this tool useful to telecommunications systems.

Optical Pulse Measurement Using Frequency-Resolved Optical Gating (FROG)

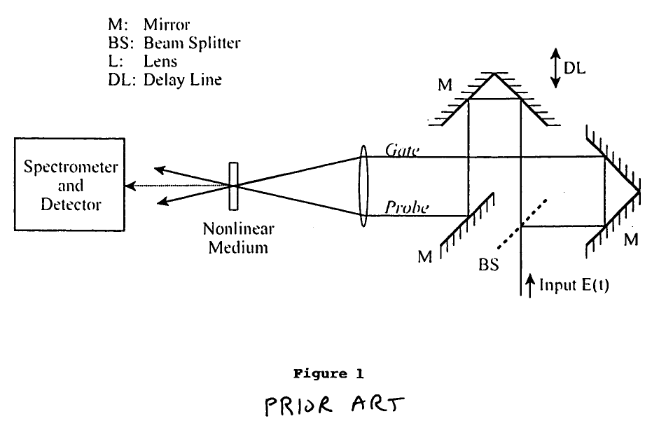

Frequency-resolved optical gating (FROG) is a technique used to measure the intensity and phase of an ultrashort laser pulse without ambiguity; it is broadband and does not require phase matching. Whereas Chilla and Martinez, J. L. A. Chilla, et al., Opt. Lett. 16, 39 (1991), measured the cross correlation of a particular frequency component of an ultrashort pulse, FROG measures the spectrum of a particular temporal component of the pulse (see FIG. 1) by spectrally resolving the signal pulse in an autocorrelation-type experiment using an instantaneously responding nonlinear medium.

As shown in FIG. 1, FROG involves splitting a pulse and then overlapping the two resulting pulses in an instantaneously responding X⁽³⁾ or X⁽²⁾ medium. Any instantaneous nonlinear interaction may be used to implement FROG. The most intuitive, however, is the polarization-gating configuration. In this case, induced birefringence due to the electronic Kerr effect is used as the nonlinear-optical process. The “gate” pulse causes the X⁽³⁾ medium, which is placed between two crossed polarizers, to become slightly birefringent. The polarization of the “gated” probe pulse is rotated slightly by the induced birefringence allowing some of the “gated” pulse to leak through the second polarizer. This is referred to as the signal. Because most of the signal emanates from the region of temporal overlap between the two pulses, the signal pulse indicates the frequencies of the “gated” pulse within this overlap region. The signal is then spectrally resolved, and the signal intensity is measured as a function of wavelength and delay time T. The resulting trace of intensity versus delay and frequency is a spectrogram, a time- and frequency-resolved transform that intuitively displays time-dependent spectral information of a waveform. A two-dimensional phase retrieval algorithm extracts the pulse from its FROG trace.

Intensity Modulator for Gating

The phase retrieval algorithm used to retrieve a pulse from its spectrogram is independent of the gating mechanism. The only constraint on the gate is that it is not infinitely long, which produces no gating, or it is not infinitely short, which produces no spectral information. According to the present invention, an intensity modulator can be used to gate the pulse to be measured just as well as an optical nonlinear effect. The intensity modulator is driven by a clock that is phase-locked to the optical pulse train. Adjusting the relative phase between the intensity modulator drive and the optical pulse train has the same effect as adjusting a time delay between the optical pulses and the gate. Thus, temporal portions of the pulse are gated and can be spectrally resolved exactly as if the pulse were gated using a nonlinear interaction between two pulses. However, as next shown, the FROG algorithm is preferably changed to a blind-FROG algorithm.

Blind-FROG

Standard FROG measurements assume that the pulse to be measured is split into two identical pulses. A more general technique, called blind-FROG, makes no assumptions about the relationship between the pulse and the gate; hence, they are unconstrained. Blind-FROG must be used when the gate is an intensity modulator with an unknown intensity gating function and the pulse is an unknown optical pulse. In fact, it can retrieve the pulse and the gate separately.

Why are not blind-FROG algorithms always used? FROG algorithms work better because of the added constraint of the gate being a function of the pulse. The loss of the FROG constraint can cause problems in producing a good retrieval because blind-FROG retrievals are ill-posed. (These problems are completely independent of the retrieval algorithm used.) Slight differences in the gate can be compensated for by opposite variations in the pulse. Noise, and especially artifacts, in the FROG trace can make matters worse. Interestingly, if the pulse and the gate are very different in either their intensity profile and/or phase, blind-FROG retrievals can be excellent. D. J. Kane, et al., J. Opt Soc. Am. B 14, 935 (1997). This is exactly the case with Lucent's work using blind-FROG to measure telecommunications pulses. C. Dorrer, et al., Opt. Lett. 27, 1315 (Aug. 1, 2002). By using a gate and pulse that were very different, together with using a commercial optical spectrum analyzer with an excellent signal-to-noise ratio, researchers at Lucent were able to retrieve both the gate and the pulse by using a PCGP algorithm (see below, the section entitled, “Obtaining the pulse intensity and phase—Principal Components Generalized Projections”).

Typically the FROG retrieval algorithm uses two constraints. The first constraint is the FROG trace. The second constraint is a mathematical form constraint specifying that the gate is functionally related to the pulse. However, in the case of blind-FROG, no mathematical form constraint is used. Thus, the only constraint is to match the retrieved FROG trace with the measured FROG trace. Blind-FROG retrievals can work provided the pulse and the gate are very different and the signal-to-noise ratio is excellent. However, if either of these conditions is not true, then the retrieved fidelity of the pulse will be poor. To get around this problem, an additional constraint can be used that forces the retrieved pulse to match its spectrum. This is called a spectral constraint.

To apply the spectral constraint, the magnitude of the Fourier transform of the retrieved pulse is replaced by the square root of the measured spectrum of the pulse being measured, at appropriate places in the phase retrieval algorithm (discussed in the next section). By forcing the spectrum of the retrieved pulse to match the spectrum of the measured pulse, the algorithm is forced to match the retrieved pulse to the measured pulse more exactly.

Unfortunately, for a commercial device, the measurement must be fast and reliable without any a priori assumptions. The measurement is further complicated by the fact that using an optical spectrum analyzer is too slow. One must sacrifice signal-to-noise and dynamic range in the FROG trace measurement for speed to make a real-time device. Consequently, spectral constraints are preferably employed to insure excellent fidelity of the pulse measurement.

Obtaining the Pulse Intensity and Phase—Principal Components Generalized Projections

A 2-D phase retrieval algorithm, H. Stark, Image Recovery: Theory and Application (Academic, Orlando, Fla., 1987), extracts the pulse information from the measured spectrogram. This algorithm converges to a pulse that minimizes the difference between the measured and the calculated FROG trace. Principal Component Generalized Projections (PCGP) provides a better solution. D. J. Kane, et al., J. Opt. Soc. Am. B 14, 935 (1997), D. J. Kane, IEEE J. Quant. Elec., 35, 421 (1999, D. J Kane, et al., IEEE J. Sel. Quant. Elec., 4, 278 (1998). PCGP is fast because it eschews the need for minimization. It is based on the idea that a FROG trace can be constructed from an outer product of two vectors representing the pulse and the gate; construction of new guesses for the pulse and gate pulses are reduced to the calculation of two eigenvectors. This calculation is implemented as very fast matrix-vector multiplications. Indeed, PCGP can retrieve pulses from FROG traces at 20 Hz and is the basis of a software package sold by Southwest Sciences called VideoFROG™. D. J. Kane, et al., J. Opt. Soc. Am. B 14, 935 (1997), D. J. Kane, IEEE J. Quant. Elec., 35, 421 (1999, D. J Kane, et al., IEEE J. Sel. Quant. Elec., 4, 278 (1998), D. J. Kane, et al., “Real-time pulse measurement using polarization-gate frequency-resolved optical gating,” Ultrafast Optics, Ascona, Switzerland (1999).

The PCGP algorithm preferably comprises the following steps:

(1) An outer product from an estimate for the pulse and the gate is constructed, called O. (The first estimate for the pulse and gate for the first iteration is usually a Gaussian with random phase.)

(2) The elements in each row are rearranged to form the time domain spectrogram of the pulse.

(3) The Fourier transform of each column is calculated.

(4) The magnitude of each element is replaced by the square root of the measured spectrogram or FROG trace (or the magnitude only if the measured quantity is not the intensity).

(5) The inverse Fourier transform of each column is taken.

(6) The steps to form the time domain spectrogram of the pulse in step 2 are reversed, reconstructing O with the intensity constraint applied.

(7) Using the power method, the next estimate for the pulse is obtained by multiplying the previous estimate of the pulse by OO^{T} and the next estimate for the gate is obtained by multiplying the previous estimate of the gate by O^{T}O.

(8) The process is repeated using the new estimate for the pulse and gate. Depending on how the outer product is constructed, different form constraints can be placed on the pulse and the gate. For example, when O^{ij}=pulseⁱgate^{j}, the inversion is said to be blind because no assumption is made about the pulse or the gate. In the case of second harmonic generation (SHG) FROG, the pulse is set to be equal to the gate, thus O^{ij}=pulseⁱgate^{j}+gateⁱpulse^{j} (D. J. Kane, et al., IEEE J. Quant. Elec. 35, 421 (1999)). Another case can occur when the gate is known, but the pulse is not known. When this is the case, O^{ij}=pulseⁱgate^{j}+pulseⁱgate_{known}^{j}, where gate_{known} is the known gate and gate is the gate found from the algorithm. When the gate is known, the algorithm is started by using the known gate for both gate_{known} and gate. However, a Gaussian with random phase can also be used for gate in the initial iteration of the algorithm. Note also, that gate_{known} is not updated and remains fixed.

To apply spectral constraints in the PCGP algorithm, the following steps are added between steps 6 and 7:

(6.1) Fourier transform each column of O.

(6.2) Replace the magnitude of each point with the square root of the pulse spectrum that has been appropriately normalized. This step can be modified to apply the spectral constraint to only columns that have a certain magnitude (or Euclidean norm).

(6.3) Inverse Fourier transform each column.

In step 6.2, any form of normalization can be used to match the magnitude of the spectral constraint to the magnitude of each column. For example, each column of the outer product matrix O will have different total sums, or a different peak value, or a different Euclidean norm. The most effective normalization is to match the Euclidean norm of the spectral constraint to the Euclidean norm of the column by multiplying the spectral constraint by the ratio of the Euclidean norm of the column to the Euclidean norm of the unnormalized spectral constraint.

Alternatively, spectral constraints can be added to the PCGP algorithm in step 1 rather than step 6. In this case, the outer product is given by O^{ij}=pulseⁱgateⁱ+pulse_{sc}ⁱgate^{j}, where “pulse” is the next estimate for the pulse, “gate” is the next estimate for the gate, and “pulse_{sc}” is the next estimate for the pulse with the spectral constraint applied. The spectral constraint is applied to the pulse in the same manner that it is applied to the column of the outer product matrix, outlined above.

The advantage of this method of applying the spectral constraint is that it requires less computation, and, therefore is faster. It also has the potential to be more stable because it is less invasive. Thus, applying the spectral constraint in this manner may prevent stagnation of the algorithm.

Traditional FROG systems require large pulse energies to drive the non-linear optical component used to gate the pulse to be measured. Telecommunication pulses are too weak for a standard FROG measurement. Consequently, it was thought to employ a system where the pulse is amplified before it is characterized using FROG. The characterized pulse would then be compared to the original, unamplified pulse using a technique known as spectral interferometry. This method is complex and expensive; it is very unlikely a device based on this method would be commercially competitive with other, less complex technologies. Second, it is not appropriate for high repetition rate systems. 10 GHz telecommunications systems have a mode spacing of 10 GHz; 40 GHz telecommunication systems have a mode spacing of 40 Ghz, etc. The modes produce a “picket fence” structure in the spectrum making spectral interferometry nearly impossible. Thus, spectral interferometric systems would require a “pulse picker” to reduce the repetition rate of the source laser, increasing the cost and needlessly complicating the system.

An improved approach exists for measuring telecommunications pulses which is simpler, inherently less expensive, and has been demonstrated successfully. A commercially available intensity modulator acts as the gate. By running the intensity modulator off the same clock as the pulse generation optics, simply adjusting the relative phase between the two drive circuits provides suitable time delays between the pulse and the gate. This method has the advantage of being universal for telecommunications pulse measurement, requiring only a few 10's of μW average power to make the FROG measurement. To recover the pulse from the FROG trace, a blind-FROG algorithm was used that made no assumptions between the pulse and the gate.

An Optical Circuit for Pulse Preparation

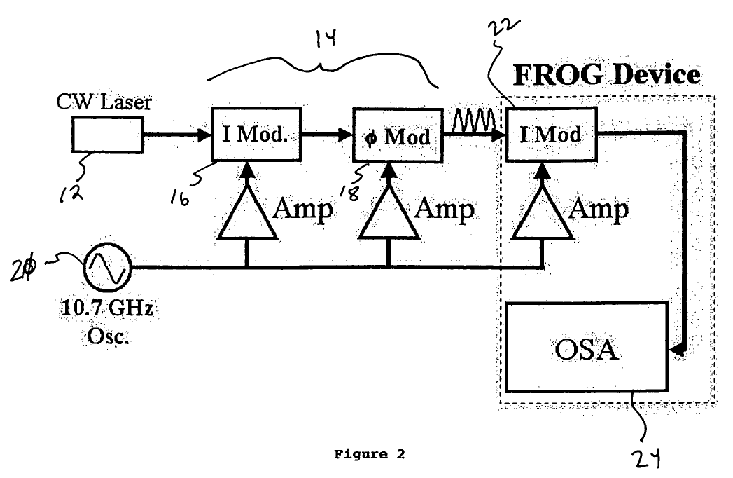

The following describes how a pulse preparation was developed that allows one to produce chirped pulses to be measured (see FIG. 2). A CW telecommunications diode laser 12 was sent into a JDS Uniphase chirped return-to-zero (RZ) pulse generator 14 designed for chirped return-to-zero modulation and dispersion-managed soliton data formatting. This pulse generator was comprised an intensity modulator 16 and a separate phase modulator 18. Each modulator is preferably driven independently.

To drive the intensity and phase modulators, a JDS Uniphase 10 Gb/s integrated clock driver and phase shifter was used. A 10.7 GHz sine wave modulation from a Hewlett-Packard 8671B Synthesized CW Generator 20 was sent into a microwave splitter. The output signals from the splitter was fed into a JDS Uniphase 10 Gb/s Integrated Clock Driver and Phase shifter which both amplified the driver modulation to levels appropriate to drive the modulators and provided a phase shift. The phase shift was voltage programmable, allowing a linear phase change over 385 degrees for control voltages from 0 to −14 volts. A circuit board was designed and built to accommodate the amplifier, provide conditioning for the analog phase shift, modulator bias, and drive modulation amplitude. Each modulator had its own driver/phase shifter to produce optical pulses with an arbitrary phase shift between the pulse intensity and the pulse phase. The amplitude of the phase could also be adjusted producing a pulse with an adjustable phase.

A Fiber Compatible FROG Device

The FROG device of the invention preferably comprises a commercially available 10 Gb/s integrated amplitude modulator 22 (JDS Uniphase 10 Gb/s integrated amplitude modulator with attenuator) for gating the input pulse train (See FIG. 2). The intensity modulator is driven by the 10 Gb/s Integrated Clock driver described above. Another splitter was added to provide the 10.7 GHz sine wave modulation for the clock driver. Phase adjustment could provide time delay through one entire cycle (93.5 ps). The spectrum of the gated pulse train is measured as a function of phase. The output from the gating intensity modulator is sent into an optical spectrum analyzer 24 (OSA) with a resolution of 15 pm (Ando AQ6317). Spectra are recorded as a function of time delay to form a spectrogram, or FROG trace, of the pulse. Spectra of the pulse and gate were also taken using the OSA.

Sixteen spectra were taken at equal intervals over a 360-degree phase shift corresponding to a 93.5 ps total optical delay. The peaks of the modes were recorded, and the complete spectrogram was interpolated and zero padded to a 64×64 image. The frequency spacing of the FROG trace was set to the mode spacing, 10.7 GHz which does not result in any lost information provided only one pulse (cycle) is to be measured. The interpolated time spacing was ˜1.5 ps (1/(64×10.7 GHz)).

Analysis

A blind-FROG, 2-dimensional, iterative phase retrieval algorithm based on principal components generalized projections (PCGP) was used to extract the pulse intensity and phase. Both the pulse and the gate were allowed to be complex. For the best accuracy, spectral constraints were applied to the pulse. Convergence of the phase retrieval algorithm was assumed once the average per pixel root-mean-square difference between the retrieved FROG trace and the measured FROG trace (FROG trace error) stagnated and remained below 1%.

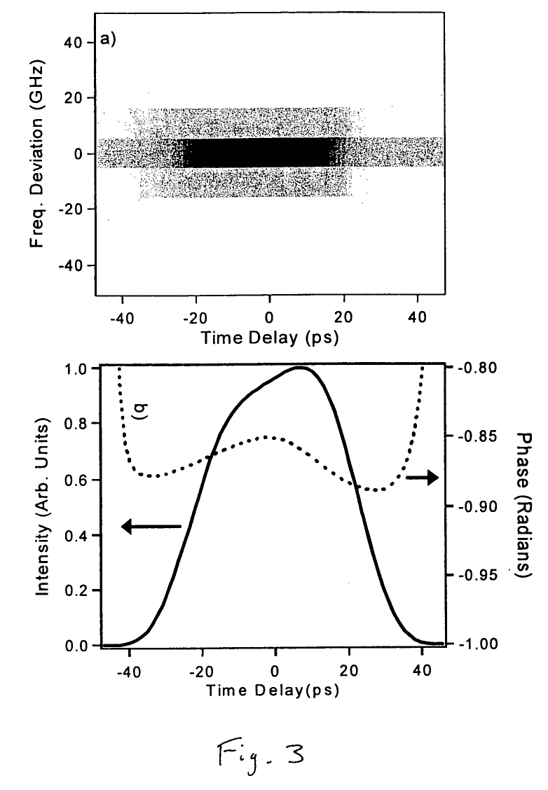

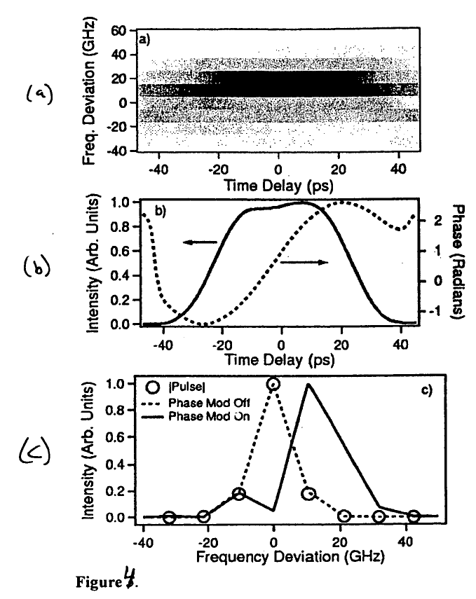

A nearly transform limited pulse was measured with the phase modulator off (FIG. 3). The rise time of the retrieved pulse was 26 ps, and the maximum phase deviation was approximately 0.025 radians. From the phase, the frequency deviation was calculated to be approximately 775 MHz, giving a chirp parameter of ˜0.12. The extinction ratio of the modulator was determined to be ˜43 dB. The spectrum of the pulse train is shown in FIG. 4(c).

FIG. 4(a) shows a FROG trace obtained from using both the intensity and phase modulator of the chirped RZ pulse generator. The phase delay on the phase modulator was adjusted to maximize the frequency shift of the pulse train. When there is no delay between the gate and pulse, the center frequency is shifted toward positive frequencies. At larger delay times, the average frequency moves back toward the center. Because the average frequency varies with time, the pulse is chirped, and the phase is not constant. FIG. 4(b) is the retrieved intensity and phase of a single pulse from the pulse train. The time domain phase of the pulse shows almost a perfect sine wave variation and has a zero crossing at approximately the center of the pulse. FIG. 4(c) shows two spectra. The spectrum marked with the solid line is the spectrum of the pulse train with the phase modulator on. The spectrum marked with the dotted line is the pulse spectrum with the phase modulator off. The circles show the square of the magnitude of the Fourier transform of the pulse magnitude, which is equivalent to the spectrum of the pulse with zero phase. The spectrum of the pulse with the phase modulator off is nearly identical to the spectrum of the magnitude of the pulse. One knows from the previous measurement that the phase of the pulse directly from the intensity modulator is nearly flat. Therefore, the retrieved intensity is accurate. The retrieved phase is accurate because the spectrum of the retrieved pulse matches the measured spectrum.

To reiterate, the FROG technique for the measurement of the intensity and phase of telecommunication pulse trains is simple, general, fast, and accurate. A device based on this method will have a bandwidth-limited rise time, a dynamic range of at least 30-40 dB, and a minimum detectable phase change of less than 0.005 radians.

Feasibility of Real-Time Measurement of Telecommunications Pulses

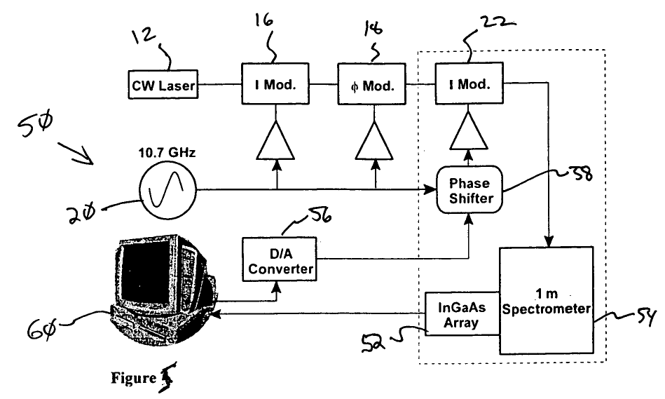

In the previous discussion, a commercially available optical spectrum analyzer was used. However, these devices are too slow for real-time FROG data acquisition. Single scans may take less than a second, but multiple scans such as the number required to obtain a FROG trace can take several seconds to a few minutes. As shown in FIG. 5, one can employ a 1 meter spectrometer 54 using a 1200g/mm grating and a 512 element InGaAs array 52. Because the A/D reading the array has a sample speed of up 1 megasample/s, the array can be read out in approximately 512 microseconds, or nearly 2 kHz. Therefore, a 64×64 FROG trace can be read out at a rate of 30 Hz-60 Hz for a 32×32 FROG trace. Because of experience with real-time analysis of FROG traces, it is known that one can retrieve pulses from FROG traces at a rate of 30 Hz for 64×64 traces. Thus, the only issue is whether or not the signal-to-noise ratio in the obtained spectra is adequate for good retrievals.

FIG. 5 is a schematic diagram of the preferred device 50 of the invention. The output from an InGaAs array 52 or like detector is read into a computer system 54 running software such as LabView®). The software displays the raw data and sends it to software such as MATLAB® for resampling down to a smaller array, such as a 32×32 array; the 32×32 FROG trace is then sent back to the software such as LabView®. Immediately before sending the spectrogram to a FROG trace inversion engine, such as a DLL written in C for maximum speed, the software such as LabView® reads the inversion results from the previous FROG trace. The process is repeated indefinitely at a rate of approximately 2 Hz on a 450 MHz Pentium® II computer. The FROG trace error was roughly 1%. Phase adjust is performed under computer 60 control via D/A converter 56 and phase shifter 58.

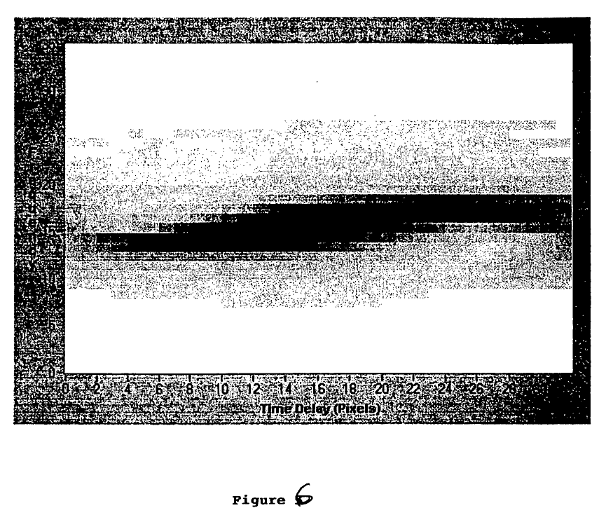

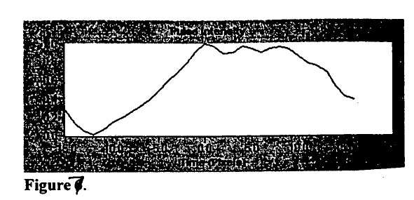

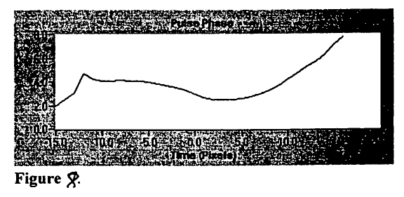

FIGS. 6-8 are plots taken from the LabView real-time pulse measurement program. FIG. 6 is the measured FROG trace. From the FROG trace it is easy to see a frequency deviation occurring within the pulse showing a strong linear chirp. FIG. 7 is the retrieved pulse intensity, and FIG. 8 is its phase. The concave up appearance of the phase is indicative of linear chirp in the pulse.

Two issues that limit real-time performance are next discussed. The first is that background on the InGaAs array affects the retrievals. The second is that a real-time FROG algorithm utilizing spectral constraints has not been developed yet. The noise level on the InGaAs array is roughly 1-bit. This together with the fact that the square-root of the FROG trace must be taken before sending it to the algorithm effectively limits the dynamic range to 6-bits. This problem may be effectively circumvented by taking the analog square-root before digitization, restoring the dynamic range. Proper analog signal conditioning can also be added.

The second performance limiting issue is that a real-time FROG algorithm utilizing spectral constraints is preferred. Spectral constraints tend to “over-constrain” the algorithm causing stagnation before convergence. One way around this is to allow the algorithm to converge without spectral constraints, and then tweak the result by introducing spectral constraints. This procedure was successfully used above to apply spectral constraints. Thus, the algorithm is allowed to run in the blind configuration, without the use of spectral constraints for a certain number of iterations-perhaps 20. The spectral constraints are then applied, and the algorithm is allowed to iterate using the spectral constraints indefinitely.

Vector optical spectrum analyzer (VOSA)

Following the invention, one can employ a vector optical spectrum analyzer (VOSA) that can fully characterize optical telecommunications pulses in real-time. This can be employed as a test and measurement device for the telecommunications industry.

The VOSA device is preferably completely self contained and approximately the size of a commercially available optical spectrum analyzer. All the user will need to do is plug the optical fiber containing the data stream into the instrument for measurement.

The instrument enclosure is preferably internally divided into three layers (sections). The first layer is preferably a Pentium® IV or like computer. The second layer contains the fiber optic circuit (intensity modulator, etc.), clock recovery circuit and any other associated conditioning electronics and optics required. The last layer contains a double-pass spectrometer with an InGaAs array or the like used as the detector.

The Pentium® IV computer in the first layer is preferably a 1 U height, server-style computer, controlled through a touch-screen on the front panel of the instrument. The computer runs all of the control electronics in the instrument as well as being responsible for both the data acquisition, data conditioning and retrieval of the pulse from its FROG trace (spectrogram). The touch-screen LCD on the front panel of the instrument also serves as the display for the pulse measurement.

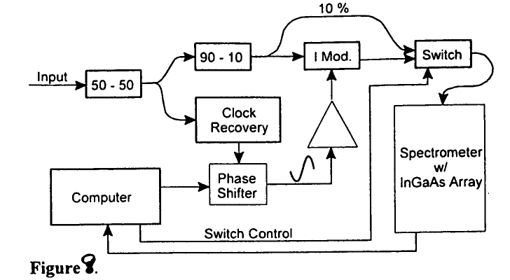

FIG. 9 shows a schematic diagram of the complete FROG device 60 according to the invention. The input optical signal is preferably split by 50-50 fiber optic coupler/splitter 62. One half of the signal goes to a clock recovery circuit 64 to generate the clock drive for the gating intensity modulator 66. The other half of the input is sent to a 90-10 fiber optic splitter 68. The 90% signal from this splitter is sent into the gating intensity modulator. The 10% signal from this splitter bypasses the intensity modulator so that it can be sent directly to the spectrometer 72 to provide the spectral constraint. A fiber optic switch 70 is used to select between the gated intensity and the full intensity. The switch is under computer 76 control.

The clock recovery circuit provides the drive for the intensity modulator. If necessary, the clock signal is filtered, then amplified (not shown). An electronic phase control 74 provides the time delay for the intensity gate. This phase control is under computer control. It should be noted that while intensity is modulated, the bias must be carefully set. However, for this application, the bias does not need to be adjusted. The shape of the gate is not important, and the retrieved gate is discarded.

The last part of the vector optical spectrum analyzer is the spectrometer. The spectrometer is preferably in a double pass configuration with a fiber optic input and an InGaAs array as the detector. A 1 m, single pass, spectrometer has a resolution of approximately 5 GHz. In an alternative spectrometer, one only needs a resolution of approximately 7 GHz to provide ample resolution for both 10 GHz as well as 40 GHz systems. Thus, one can make the spectrometer smaller, and the spectrometer in our prototype will be roughly a ¾ m double pass—approximately 14 inches deep.

In experimentation it was found that the InGaAs array used had roughly +/−1-bit of noise when using a 12-bit A/D. The main problem found was that when taking a square-root of the FROG trace, before inputting it into the retrieval algorithm, one faced a loss of dynamic range. By taking an analog square-root, the full dynamic range of the digitized image could be recovered. Thus, in the preferred vector optical spectrum analyzer, one needs electronics to take the analog square-root of the signal from the InGaAs array before it is digitized.

VOSA Software

To insure accurate pulse retrievals under all conditions, spectral constraints must be used. However, spectral constraints can cause the algorithm to converge slowly or stagnate. Consequently, one preferably employs a blind-FROG algorithm that can be used in a real-time pulse measurement system. One can allow the algorithm to converge without spectral constraints, then apply the spectral constraints to tweak the solution.

A computer with a touch-screen is preferred to simplify the user interface. The computer preferably has a full operating system that will allow for a graphical user interface (GUI) development. This instrument competes with both high-speed digital sampling oscilloscopes and optical spectrum analyzers.

Analysis of Polarization Mode Dispersion

An issue of major importance in telecommunications systems is the evaluation of polarization mode dispersion. One can employ a system, based on real-time pulse measurement device, that can measure the temporal dynamics of the polarization state of the pulse using a technique called time resolved ellipsometry. If one can resolve the time dependent polarization state of the pulse, one can measure higher-order (beyond second order) polarization mode dispersion of the pulse.

Time resolved ellipsometry measurements are made by measuring the intensity and phase of all four Stokes parameters. (Two polarizations are not enough because FROG does not measure the absolute phase of the pulse.)

Phase Gating for Pulse Measurement

The present invention is not limited to using an intensity gate for measuring the intensity and phase of an ultrashort laser pulse. A phase gate can be used as well. That is, a phase modulator can be used instead of an intensity modulator the FROG device. In this case, the phase modulation supplied to the phase modulator is time delayed (phase shifted) with respect to the pulse to be measured while a spectrum is recorded at each time delay. This technique has the advantage of having a known gate. Phase modulators are easier to calibrate and keep in calibration than intensity modulators. Thus, the known phase can be placed into the inversion algorithm. Furthermore, because the phase, and therefore the gate, is known, spectral constraints are not required to produce accurate retrievals although they can be used to further improve accuracy by making the retrieval more robust against noise.

### INDUSTRIAL APPLICABILITY

The invention is further illustrated by the following non-limiting examples.

### EXAMPLE 1

A repetitive pulse train in the microwave region can be measured by using a mixer as the gate. The driving sine wave to the gate input on the mixer can be phase shifted relative to the pulse train to be measured. The output from the mixer can be spectrally resolved using a spectrum analyzer.

### EXAMPLE 2

An acoustic waveform can be measured by using a gate that slices portions of the acoustic waveform that can be spectrally resolved. As the relative time between the pulse and the gate is changed, a spectrum of the gated acoustic waveform is taken. The resulting spectrogram is inverted using a phase retrieval algorithm.

### EXAMPLE 3

A sonogram of a pulse can be taken by measuring the time arrival of spectral slices of the pulse to be measured. In this case, the gate is a spectral gate, which removes all but a few frequencies from the pulse to be measured. The resulting waveform is measured as a function of the spectral position of the gate. The resulting sonogram can then be inverted using the PCGP algorithm. A sonogram is the Fourier transform analog of a spectrogram.

### EXAMPLE 4

This technique can also be used in imaging. For example assume a microscope is examining an object. The transfer function of the microscope is the gate while the object being examined can be thought of as the pulse. Recording the Fourier transform of the portion of the object viewed by the microscope as a function of position produces a type of spectrogram of the object. By obtaining the phase of the spectrogram, the object can be determined independent of the transfer function of the microscope.

The examples can be repeated with similar success by substituting the generically or specifically described reactants and/or operating conditions of this invention for those used in the preceding examples.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above, and of the corresponding application(s), are hereby incorporated by reference.

What is claimed is:

1. An apparatus for optical pulse characterization, said apparatus comprising:
a modulator receiving optical pulses;
a spectrometer receiving output from said modulator;
a detector receiving output from said spectrometer;
a phase shifter receiving a gate pulse and providing output to said modulator; and
information processing means receiving output from said detector and providing commands to said phase shifter.

2. The apparatus according to claim 1 wherein said apparatus characterizes optical pulses as to one or more of the group consisting of intensity, phase, dispersion, polarization states, chirp, and non-linear effects.

3. The apparatus of claim 1 wherein said modulator is phase-locked to a train of the optical pulses.

4. The apparatus of claim 3 wherein said phase shifter provides a same effect as adjusting a time delay between the optical pulses and the gate pulse.

5. The apparatus of claim 1 wherein said information processing means comprises frequency-resolved optical gating means.

6. The apparatus of claim 5 wherein said frequency-resolved optical gating means makes no constraint between optical pulse and gate pulse.

7. The apparatus of claim 6 wherein a spectral constraint is applied to said frequency-resolved optical gating means.

8. The apparatus of claim 5 wherein said information processing means additionally comprises principal components generalized projections means.

9. The apparatus of claim 8 wherein said principal components generalized projections means employs a spectral constraint.

10. The apparatus of claim 1 wherein said modulator is selected from the group consisting of an intensity modulator and a phase gate.

11. A method for optical pulse characterization, the method comprising comprising the steps of:
receiving optical pulses via a modulator;
receiving output from the modulator via a spectrometer;
receiving output from the spectrometer via a detector;
receiving a gate pulse via a phase shifter and providing output to the modulator; and
receiving output from the detector via information processing means and providing commands to the phase shifter.

12. The method according to claim 11 additionally comprising the step of characterizing optical pulses as to one or more of the group consisting of intensity, phase, dispersion, polarization states, chirp, and non-linear effects.

13. The method of claim 11 additionally comprising the step of phase-locking the modulator to a train of the optical pulses.

14. The method of claim 13 wherein the phase shifter provides a same effect as adjusting a time delay between the optical pulses and the gate pulse.

15. The method of claim 11 additionally comprising the step of employing the information processing means to perform frequency-resolved optical gating.

16. The method of claim 15 wherein the frequency-resolved optical gating makes no constraint between optical pulse and gate pulse.

17. The method of claim 16 wherein a spectral constraint is applied to the frequency-resolved optical gating.

18. The method of claim 15 additionally comprising the step of employing the information processing means to perform principal components generalized projections.

19. The method of claim 18 wherein the principal components generalized projections employs a spectral constraint.

20. The method of claim 11 wherein the modulator is selected from the group consisting of an intensity modulator and a phase gate.

21. A vector optical spectrum analyzer comprising:
a modulator receiving optical pulses;
a spectrometer receiving output from said modulator;
a detector receiving output from said spectrometer;
a phase shifter receiving a gate pulse and providing output to said modulator;
information processing means receiving output from said detector and providing commands to said phase shifter; and
a clock recovery circuit providing said gate pulse to said phase shifter.

22. The vector optical spectrum analyzer of claim 21 additionally comprising a switch providing input to said spectrometer alternatable between output of said modulator and optical pulses as received by said modulator.

23. The apparatus of claim 5 wherein gate is known.

24. The method of claim 15 wherein gate is known.
